(19) United States
(12) Patent Application Publication
(10) Pub. No.: US 2003/0236695 A1
(43) Pub. Date: Dec. 25, 2003

(54) Method for media popularity determination by a media playback device

(76) Inventor: Louis Robert Litwin JR., Plainsboro, NJ (US)

Correspondence Address: Joseph S. Tripoli, THOMSON multimedia Licensing Inc., Two Independence Way, P.O. Box 5312, Princeton, NJ, 08543-5312, US

(21) Appl. No.: 10/176,598

(22) Filed: Jun. 21, 2002

(51) Int. Cl. G06F 17/60

(52) U.S. Cl. 705/10

(57) ABSTRACT

There is provided a method for determining the popularity of media files for a media playback device. The method comprises using a popularity metric manager for at least one of creating and updating popularity metrics for media files that are stored on the media playback device, wherein the popularity metrics are related to the playback of the media files by a user of the media playback device. The method then updates the playback device with files in accordance with the determined popularity metrics.

### BACKGROUND OF THE INVENTION

1. Field of the Invention

The present invention generally relates to media playback devices and, more particularly, to a method and apparatus for determining and using media popularity by one or more media playback devices.

2. Background of the Invention

Generally, in contrast to media playback devices found in substantially stationary computers (e.g., desktop personal computers (PCs), workstations, servers, and so forth), portable media playback devices (e.g., MP3 audio players, personal digital assistants (PDAs), Ebooks, laptops, and so forth) have limited memory resources for storing media files. Thus, while a user will typically have a large number of media files (e.g., MP3 files, MPEG files, JPEG files, and so forth) stored on his or her PC hard drive, the portable media playback device of the user is generally capable of storing only a fraction of those media files. Thus, the user must selectively decide which songs to download onto his or her portable media playback device.

As an example, given the popularity of MP3 audio files, many people have collections of MP3 audio files on their home computer. Such collections can run up to tens, hundreds, and even thousands of MP3 files. Given the huge selection of songs available for download, and the limited memory of portable MP3 players as well as, in some circumstances, home computers already congested with many songs and other files, it is often hard for a user to make up his mind as to which songs to download. Some software on the PC allows the user to sort the selections by Most Recently Downloaded or Most Often Downloaded. However, just because a song was downloaded recently or most often doesn't mean that it is one of the user's favorites. For example, a user may download files without actually ever playing them. Moreover, the user may only play part of a song and then skip to the next song. Further, while the user may have several play lists of songs that he or she likes and which he or she downloads in their entirety, for the user typically listens to a few of the songs instead of going through the entire play list.

Accordingly, it would be desirable and highly advantageous to have a method and apparatus for ranking a plurality of media files based on a useful metric other than most recently or most often downloaded. Such a method and apparatus can be advantageously used to aid an individual in selecting from among a plurality of media files which of those files he or her should download (e.g., to a portable media playback device) and/or which of those files should be deleted.

### SUMMARY OF THE INVENTION

A method and apparatus for determining media popularity by a media playback device based on a popularity metric assigned to the usage of a media selection played on a media playback device, for selecting media to be stored in the media playback device.

### BRIEF DESCRIPTION OF THE DRAWINGS

FIG. 1 is a block diagram illustrating a computer system 100 to which the present invention may be applied, according to an illustrative embodiment of the present invention;

FIG. 2 is a block diagram illustrating a portable media playback device 200 according to an illustrative embodiment of the present invention;

FIG. 3 is a block diagram illustrating a popularity metric manager 210 shown in FIG. 2, according to an illustrative embodiment of the present invention;

FIG. 4 is a block diagram illustrating a popularity metric manager 210 shown in FIG. 2, according to another illustrative embodiment of the present invention; and

FIG. 5 is a block diagram illustrating a method for determining and using media popularity by media playback devices, according to an illustrative embodiment of the present invention.

### DETAILED DESCRIPTION OF THE INVENTION

The present invention is directed to a method and apparatus for determining media popularity by a media playback device. For illustrative purposes, the present invention is described with respect to a portable MP3 audio player. However, it is to be appreciated that the present invention may be applied to any type of media playback device, portable (e.g., MP3 audio players, personal digital assistants (PDAs), Ebooks, laptops, and so forth), memory resource/devices that are accessible through a network connection (e.g., personal computers, websites, File Transport Protocol (FTP) locations, devices accessed through peer to peer connections as a NAPSTER or the like, and so forth), and/or substantially stationary (e.g., desktop PCs, workstations, servers, mainframes, and so forth). Moreover, it is to be further appreciated that the present invention may be applied to any type of digitally storable media file including audio files (e.g., MP3 files, WAV files, and so forth), video files (MPEG files, JPEG files, and so forth), multimedia files, and so forth.

The media playback device will monitor the user's usage (e.g., how long user listens to and/or watches a media, whether the user listens to or watches a complete media file and/or a portion thereof, and so forth) of each media selection and assign a popularity metric to each selection. The popularity metrics can be sorted based on popularity and/or unpopularity, and used to, for example, decide which files to download from a substantially stationary computer (e.g., desktop PC) to a portable media playback device (e.g., MP3 player), which files to delete from the substantially stationary computer and/or the portable media playback device, and so forth.

According to preferred embodiments of the present invention, values of the popularity metrics may be combined/updated from one media playback device to another media playback device. Given the teachings of the present invention provided herein, one of ordinary skill in the related art will contemplate these and various other uses for popularity metrics obtained in accordance with the present invention, while maintaining the spirit and scope thereof.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

Accordingly to one aspect of the present invention, there is provided an apparatus for a media playback device. The apparatus comprises a popularity metric manager for at least one of creating and updating popularity metrics for media files that are stored on the media playback device, wherein the popularity metrics are related to the playback of the media files by a user of the media playback device.

According to another aspect of the present invention, there is provided a method for using media files on a media playback device. The method comprises the step of at least one of creating and updating popularity metrics for the media files that are stored on the media playback device, wherein the popularity metrics are related to the playback of the media files by a user of the media playback device.

These and other aspects, features and advantages of the present invention will become apparent from the following detailed description of preferred embodiments, which is to be read in connection with the accompanying drawings.

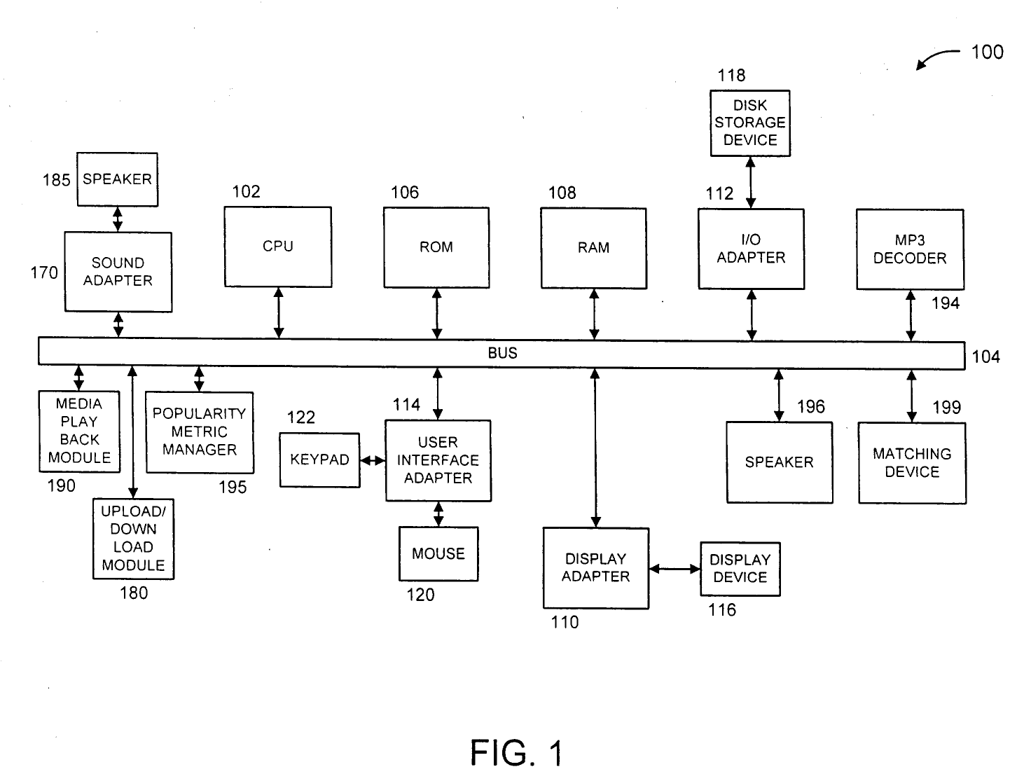

FIG. 1 is a block diagram illustrating a computer system 100 to which the present invention may be applied, according to an illustrative embodiment of the present invention. The computer processing system 100 includes at least one processor (CPU) 102 operatively coupled to other components via a system bus 104. A read only memory (ROM) 106, a random access memory (RAM) 108, a display adapter 110, an I/O adapter 112, a user interface adapter 114, and a sound adapter 170 are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

At least one loudspeaker (hereinafter “loudspeaker”) 185 is operatively coupled to system bus 104 by sound adapter 170.

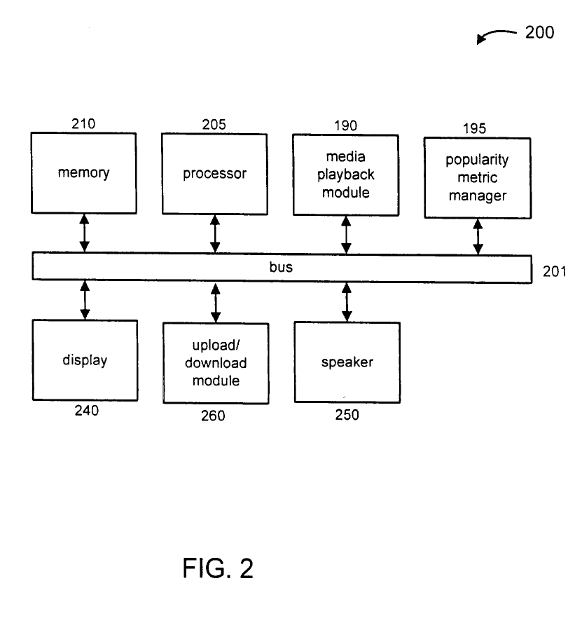

The computer system 100 further includes an upload/download module 180. The upload/download module 180 is for managing an upload of media and/or popularity metrics from another media playback device and for managing a download of media and/or popularity metrics to another media playback device (e.g., such as the portable media playback device shown in FIG. 2). In the event that the computer system 100 is the only media playback device used by a user (e.g., the user does not also use a portable media playback device, storage medium/device accessible through a network connection, or other substantially stationary computer), then the download module 180 may be omitted from the computer system 100.

The computer system 100 may optionally include a media playback module 190 and a popularity metric manager 195 that function as described below with respect to the portable media playback device 200 of FIG. 2.

It is to be appreciated that both the computer system 100 of FIG. 1 and the portable media playback device 200 of FIG. 2 may include the popularity metric manager 195 so that the popularity of media may be determined on both the computer system 100 and the portable media playback device 200. However, it is to be appreciated that the popularity metric manager 195 may be omitted from the computer system 100 so that popularity of the media is based solely on the playback of the media on the portable media playback device 200. Given the teachings of the present invention provided herein, one of ordinary skill in the related art will contemplate these and various other configurations of the elements of FIGS. 1 and 2, while maintaining the spirit and scope of the present invention.

FIG. 2 is a block diagram illustrating a portable media playback device 200 according to an illustrative embodiment of the present invention. The portable media playback device 200 includes a processor 205, a memory 210, a media playback module 190, a popularity metric manager 195, a display 240, at least one loudspeaker (hereinafter “loudspeaker” 250), and an upload/download module 260. The memory 210 stores media files. The media playback module 190 plays back the media files stored in the memory 210. The popularity metric manager 195 computes/updates a popularity of each of the media files. The display 240 displays information related to the playback of the media files. The loudspeaker 250 audibly reproduces audio related to the playback of the media files. The upload/download module 180 is for managing an upload of media and/or popularity metrics from another media playback device and for managing a download of media and/or popularity metrics to another media playback device (e.g., such as the portable media playback device shown in FIG. 2). In a preferred embodiment of the present invention, the portable media playback device 200 is a portable MP3 audio player and, hence, the media playback module 190 is an MP3 decoder. However, as noted above, the present invention may be applied to any type of media playback device, while maintaining the spirit and scope of the present invention.

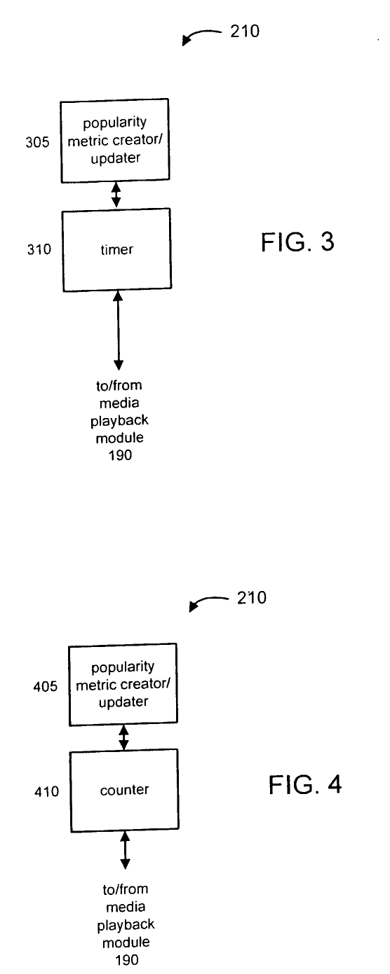

FIG. 3 is a block diagram illustrating a popularity metric manager 210 shown in FIG. 2, according to an illustrative embodiment of the present invention. The popularity metric manager 210 includes a popularity metric creator/updater 305 and a timer 310. The timer 310 times the duration that a complete song and/or a portion of a song are played back on the playback device. The popularity metric creator/updater 305 creates and/or updates popularity metrics based at least on an output of the timer 310. Given the teachings of the present invention provided herein, one of ordinary skill in the related art will contemplate these and various other uses of the timer 310 for the purpose of computing the popularity metric for a given media, while maintaining the spirit and scope of the present invention.

FIG. 4 is a block diagram illustrating a popularity metric manager 210 shown in FIG. 2, according to another illustrative embodiment of the present invention. The popularity metric manager 210 includes a popularity metric creator/updater 305 and a counter 410. The counter 410 counts each time a particular song is played back (either fully, partially, after a pre-determined minimum amount of time, and so forth). The popularity metric creator/updater 305 creates, compares, and/or updates popularity metrics based at least on an output of the counter 410. Given the teachings of the present invention provided herein, one of ordinary skill in the related art will contemplate these and various other uses of the counter 410 for the purpose of computing the popularity metric for a given media, while maintaining the spirit and scope of the present invention.

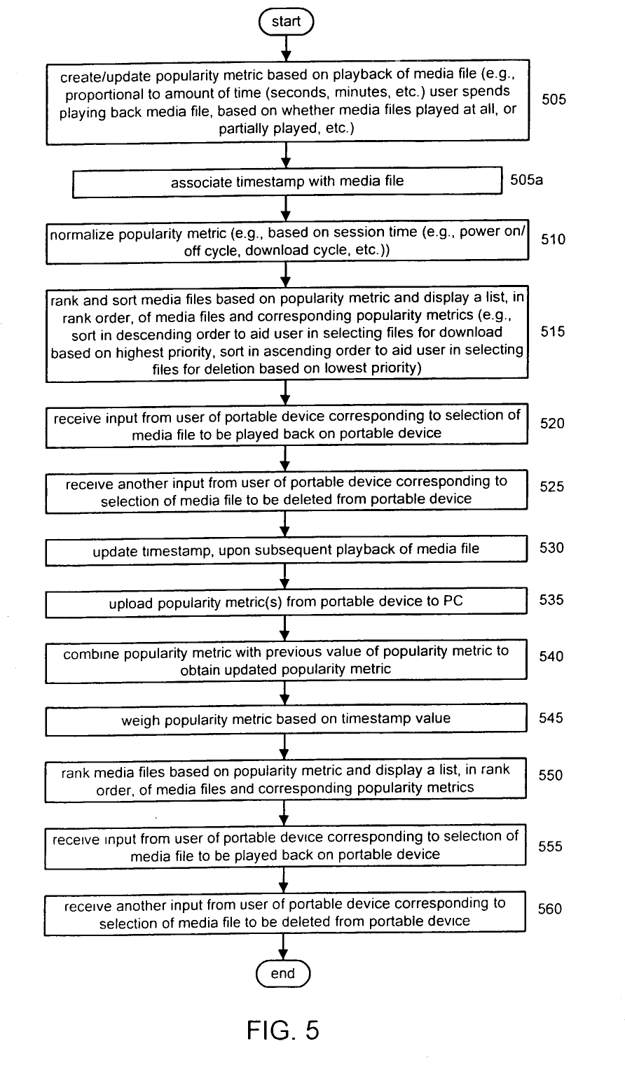

FIG. 5 is a block diagram illustrating a method for determining and using media popularity by media playback devices, according to an illustrative embodiment of the present invention. In the illustrative embodiment of FIG. 5, the media playback devices include a portable media playback device and a substantially stationary media playback device. Moreover, in the illustrative embodiment of FIG. 5, the portable media playback device is a portable MP3 audio player and the substantially stationary media playback device is a desktop PC having a media playback device included therein. Of course, as noted above, the present invention is not limited to the preceding types of media playback devices and hosts thereof and, thus, other types of media playback devices and hosts may also be used while maintaining the spirit and scope of the present invention. Moreover, the present invention may be used with any number of media playback devices, including only one media playback device or as many media playback devices as desired.

Given the teachings of the present invention provided herein, one of ordinary skill in the related art will contemplate these and various other configurations and implementations of the present invention while maintaining the spirit and scope thereof.

Upon a user playing back a media file on the portable media playback device, a popularity metric is created/updated for the media file that is related to the playback of the media file by the user (step 505). Preferably, the popularity metric is proportional to the amount of time that the user spends playing back the media file. A number preferably represents the popularity metric; however, other representations may also be employed while maintaining the spirit and scope of the present invention. Step 505 may include the step of associating a timestamp with the popularity metric (step 505a). The timestamp corresponds to the last playback time of the media file. The timestamp may be used to weigh the popularity metric such that if the media file corresponding to the popularity metric has not been played recently, then the value of the popularity metric would be reduced over time to reflect its decreasing popularity. The value of the popularity metric can be reduced by the portable media playback device and/or the PC. It is to be appreciated that the reduction can be performed at pre-defined time intervals, at random time intervals, or at some other time(s).

The computing/updating of the popularity metric at step 505 may be based upon the actual time and/or multiple of some quantity of time (e.g., seconds, minutes, etc.) that the media file is played back. For example, one approach would be to compute a metric that increments for every second that the media is played back. Thus, if a media selection is 1 minute and 20 seconds long, and the user played back the entire selection and then rewound it to replay the last 20 seconds, the popularity metric would be proportional to 1 minute and 40 seconds. Another approach would be to increment the popularity metric whenever the media selection is played in it entirety; however, this approach is not as useful because, for example, users often skip to the next song during the final seconds of the current song. Moreover, another approach would be to increment the popularity metric if even a portion of a particular selection is played back or at least some pre-determined amount of time of that selection. In a preferred embodiment of the present invention, the first approach is employed (i.e., popularity metric is proportional to the actual number of seconds that the media file is played). It is to be appreciated that the present invention is not limited to the preceding approaches for computing the popularity metric and, thus, other approaches to computing the popularity metric based in some way to playback time may also be used while maintaining the spirit and scope of the present invention.

The popularity metric may optionally be normalized (step 510). One illustrative way to normalize the popularity metric is to scale the metrics based on the total amount of time that the portable media playback device was used in one or more sessions (e.g., with a single session corresponding to power on/power off with intervening playback, a new download, and so forth). Thus, consider the case that the popularity metric was incremented by 1 for every second that a given song was played, the given song was played for a total of 800 seconds, and the portable media playback device has been used for a total of 4000 seconds since the latest download to the portable media playback device. The popularity metric would be scaled such that the normalized popularity metric would be 800/4000=0.2. An optional embodiment of the invention would assign additional weights to attributes related to files for the normalization step, (e.g., the genre of a played as Rock or Jazz, biographical information related to a file, copyright year of a file, file recording quality [44 KHz is better than a song sampled at 22 KHz], encoder type used to create a file [a MP3PRO encoding over a MP3 encoding] and so forth). This attribute information may be included from such identification methods as CDDB, a MUSE™ supported database, MP3 ID files, file headers, and so forth.

It is to be appreciated that the present invention is not limited to the preceding normalization approach and, thus, other approaches to normalizing the popularity metric may also be used while maintaining the spirit and scope of the present invention.

The media files stored on the portable media playback device may be ranked (e.g., ascending or descending order) based on their corresponding popularity metric and displayed in a list along with their corresponding popularity metric in rank order (step 515). An input may then be received from the user of the portable media playback device corresponding to a selection of a media file that is to be played back next on the portable media playback device, with the selection preferably based on the popularity metrics (step 520). Moreover, another input may be received from the user of the portable media playback device corresponding to another selection by the user of one or more other media files that are to be deleted from the portable media playback device, the other selection also preferably based on the popularity metrics (step 525). Optionally, the user can set forth a threshold metric to be used to update files, for example all files that have not been played for a specific time duration would be deleted. Other types of updating procedures may be done within the scope and spirit of the present invention.

Upon the user again playing back the media file on the portable media playback device, the time stamp associated with the popularity metric for that media file is updated (step 530). This enables a determination to be made as to when the media file was last played back.

The popularity metric(s) is then uploaded from the portable media playback device to the desktop PC, along with any other popularity metrics for any other media files (step 535).

The popularity metric for the given media file is combined with a previous value of the popularity metric for the given media file (already stored on the PC) to obtain an updated popularity metric for the given media file (step 540). It is to be appreciated that while the popularity metric was normalized by the portable media playback device at step 510, alternatively, the popularity metric may be normalized by the PC prior to combining the popularity metric with the previous value of the popularity metric stored on the PC. Moreover, as another alternative, the popularity metric may be again normalized by the PC in addition to the normalization implemented by the portable media playback device. It is to be appreciated that the normalization approaches used by the portable media playback device and the PC may differ or may the same.

The popularity metric may be weighted based on time such that if the media file corresponding to the popularity metric has not been played recently, then the value of the popularity metric would be reduced over time to reflect it decreasing popularity (step 545). In this case, the timestamp associated with the popularity metric at step 505a would be used to reduce the value of the popularity metric.

The media files stored on the PC may be ranked (e.g., ascending or descending order) based on their corresponding popularity metric and displayed in a list, in rank order, along with their corresponding popularity metric (step 550). An input may then be received from the user of the PC corresponding to a selection by the user of a media file is to be played back next on the PC, preferably based on the popularity metrics (step 555). Moreover, another input may be received from the user of the PC corresponding to another selection by the user of one or more other media files that are to be deleted from the PC, the other selection also preferably based on the popularity metrics (step 560).

As noted earlier, one embodiment of the invention supports one or more playback devices for determining a metric for storing songs for playback. For example, the present invention may determine a master playlist from the metrics determined from the metrics from multiple playback devices where the respective metrics would be normalized together. For instance, if playlist one of a first playback device has a listed song as played for 200 seconds, and a playlist two had a listed song as played for 400 seconds, the master play list would list the song that played for 400 seconds over the song that played for 200 seconds. Various parameters may be considered in determining this normalization process, as weighting the playback of a song on one playback device higher than that of a second playback device (song origin), other attributes listed above, and so forth.

Furthermore, the master playlist can be used to determine what songs should be stored on a multiple of devices. For instance, once the master playlist is determined, multiple playback devices may be updated with the selections presented on the master playlist, provided that such files are available. Optionally, a user may purchase the unavailable files from a location as a website via a subscription service (as PRESSPLAY™, REALONE™, and so forth) if the playback device has a network connection to the Internet. If a song were not available, the playback device would skip the missing file, and update the playback device with the next available file. The update would continue until a certain threshold is met (e.g., the top 10 available songs on the master list, all songs played for at least 2000 seconds, updating the player to fill 10 MB of space, and so forth.). The master playlist may also be transmitted to a website for displayed, for example the master playlist is formatted in HTML code for formatting on a website, and/or for other media devices to receive files that are determined to be popular, in accordance with the developed popularity metrics.

Thus, in sum, the present invention bases the popularity of a particular media file (e.g., MP3 song) with a given user in consideration of how much time the user spends playing back the media file. Advantageously, the present invention provides an accurate measure of that popularity and furthermore, it provides a means for assisting the user in selecting media files to play on his her media playback device, to download to a portable media playback device, and to delete from any of his or her media playback devices.

Although the illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for using media files on a media playback device, comprising the step of at least one of creating and updating popularity metrics for the media files that are stored on the media playback device, wherein the popularity metrics are related to the playback of the media files by a user of the media playback device.

2. The method of claim 1, wherein each of the popularity metrics is proportional to an amount of time that the user plays back a corresponding one of the media files.

3. The method of claim 1, wherein each of the popularity metrics is based on whether the user has played back a corresponding one of the media files at all, or whether the user has played back a predetermined portion of a corresponding one of the media files.

4. The method of claim 1, further comprising the step of normalizing the popularity metrics.

5. The method of claim 4, wherein said normalizing step normalizes the popularity metrics based on a total amount of time that the media playback device was used.

6. The method of claim 1, further comprising the step of ranking the media files stored on the media playback device based on the popularity metrics.

7. The method of claim 6, further comprising the step of displaying the media files in rank order along with the popularity metrics corresponding thereto.

8. The method of claim 7, wherein the media files are sorted in descending order of popularity to aid the user in selecting which of the media files to download to another media playback device based on highest popularity.

9. The method of claim 7, wherein the media files are sorted in ascending order of popularity to aid the user in selecting which of the media files to delete based on lowest popularity.

10. The method of claim 1, further comprising the step of associating a timestamp with each of the popularity metrics, the timestamp for indicating a last playback time of a corresponding media file.

11. The method of claim 10, further comprising the step of adjusting a value of each of the popularity metrics based on the timestamp such that the value is reduced in relation to how long ago a corresponding media file was last played back.

12. The method of claim 1, further comprising the step of at least one of uploading at least the popularity metrics to another media playback device and downloading at least the popularity metrics to the other media playback device.

13. The method of claim 1, further comprising the step of respectively combining a current value of at least one of the popularity metrics with a previous value of the at least one of the popularity metrics to obtain an updated value for the at least one of the popularity metrics.

14. The method of claim 1, further comprising the step of obtaining at least one of the current value and the previous value from another media playback device.

15. The method of claim 1, further comprising the step of updating files on the playback device, wherein said updating step updates the playback device with files with a value exceeding a threshold value or updates the playback device with files below a threshold value.

16. The method of claim 1, wherein said popularity metrics include at least one of: a genre of a file played, biographical information related to a file, copyright year of a file, file recording quality, and an encoder used to create a file.

17. A method of organizing a plurality of media files stored in a memory resource comprising the steps of:
attributing a metric to a media file from the plurality of data files, wherein said metric is related to playback of the media file;
ranking the media file in comparison to information comprising a metric attributed to an other media file from a second memory resource;
updating the memory resource in accordance with the rankings established in said ranking step.

18. The method of claim 17, further comprising a step of generating a playlist in accordance with said ranking step.

19. The method of claim 18, wherein said playlist is displayed on a website.

20. The method of claim 17, wherein said updating step removes the media file from said memory resource when the media file has a metric below a threshold value.

21. The method of claim 17, wherein said updating step updates the memory resource with the other media file from the second memory resource when available.

22. The method of claim 21, wherein the other media file is made available via a subscription service.

23. The method of claim 17, wherein said ranking step includes a metric related to at least one of: weighting information considering an origin of the media file, a genre of the media file played, biographical information related to the media file, copyright year of the media file, the media file recording quality, and an encoder used to create the media file.
